(19) United States
(12) Patent Application Publication
(10) Pub. No.: US 2009/0091419 A1
(43) Pub. Date: Apr. 9, 2009

(54) METHODS AND SYSTEMS TO CONTROL REMOTE ACCESS TO A VEHICLE MODULE

(75) Inventors: Ansaf I. Alrabady, Livonia, MI (US); Michael Jay Abowd, Ann Arbor, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 11/868,819

(22) Filed: Oct. 8, 2007

(51) Int. Cl. G08B 29/00

(52) U.S. Cl. 340/5.2

(57) ABSTRACT

A method for controlling remote access to a module of a vehicle includes the steps of determining whether the vehicle is in a predetermined state, and permitting remote access to the module only on the condition that the vehicle is in the predetermined state.

### TECHNICAL FIELD

The present invention generally relates to the field of vehicles and, more specifically, to methods and systems for controlling remote access to a vehicle module.

### BACKGROUND OF THE INVENTION

Vehicle manufacturers, dealers, and service centers require access to various vehicle modules under certain situations. For example, vehicle manufactures, dealers, and service centers may require access to an engine control unit (ECU) module of a vehicle to ascertain data as to the state or condition of the vehicle, to perform diagnostics on the vehicle, and/or to program, reprogram, and/or update the ECU module. Access to vehicle modules is generally provided via a hard wire connection to the vehicle. However, use of such hard wire connections can be less than ideal in certain situations, for example if modules of a number of vehicles need to be accessed and/or if a vehicle is not in close proximity to the computer or other equipment used to perform the desired tasks for which access to the vehicle module is required. If remote access to vehicle modules is offered, unless it is secure, it could potentially be problematic if unauthorized users are able to remotely access the vehicle modules.

Accordingly, it is desired to provide systems for controlling remote access to a vehicle module, for example such that only authorized users are allowed remote access. It is also desired to provide methods for controlling remote access to a vehicle module, for example such that only authorized users are allowed remote access. Furthermore, other desirable features and characteristics of the present invention will be apparent from the subsequent detailed description and the appended claims, taken in conjunction with the accompanying drawings and the foregoing technical field and background.

### SUMMARY OF THE INVENTION

In accordance with an exemplary embodiment of the present invention, a method for controlling remote access to a module of a vehicle is provided. The method comprises the steps of determining whether the vehicle is in a predetermined state, and permitting remote access to the module only on the condition that the vehicle is in the predetermined state.

In accordance with another exemplary embodiment of the present invention, a program product for controlling remote access to a module of a vehicle is provided. The program product includes a program and a computer-readable signal-bearing media. The program is configured to at least facilitate determining whether the vehicle is in a predetermined state, and permitting remote access to the module only on the condition that the vehicle is in the predetermined state. The computer-readable signal-bearing media bears the program.

In accordance with a further exemplary embodiment of the present invention, a system for controlling remote access to a module of a vehicle is provided. The system comprises a sensing device and a processor. The sensing device is configured to sense a physical vehicle measure. The processor is coupled to the sensing device. The processor is configured to at least facilitate determining whether the vehicle is in a predetermined state, based on the physical vehicle measure, and permitting remote access to the module only on the condition that the vehicle is in the predetermined state.

### DESCRIPTION OF THE DRAWINGS

The present invention will hereinafter be described in conjunction with the following drawing figures, wherein like numerals denote like elements, and wherein:

FIG. 1 is a functional block diagram showing a system for controlling remote access to a module of a vehicle in accordance with an exemplary embodiment of the present invention; and

FIG. 2 is a flowchart of a process for controlling remote access to a module of a vehicle that can be implemented in connection with the system of FIG. 1 in accordance with an exemplary embodiment of the present invention.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

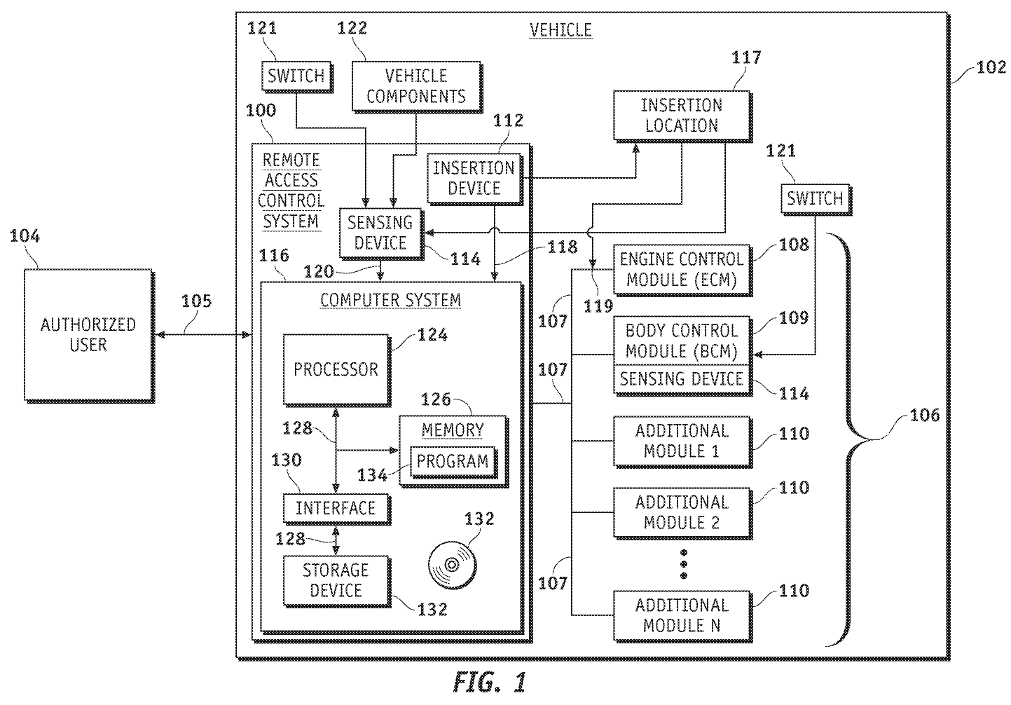

FIG. 1 is a functional block diagram showing a remote access control system 100 in a vehicle 102 in accordance with an exemplary embodiment of the present invention. Specifically, the remote access control system 100 selectively permits an authorized user 104 to remotely access, such as through a wireless network 105, one or more modules 106 of the vehicle 102. In the depicted embodiment, the modules 106 of the vehicle 102 for which remote access may be sought include an engine control unit (ECM) module 108, a body control module (BCM), and/or various other additional modules 110. For example, the additional modules 110 may include a braking module, a transmission module, a steering wheel module, an air conditioning module, a radio module, and/or any number of other types of vehicle modules. As shown in FIG. 1, in this embodiment the various modules 106 are networked together, and to the remote access control system 100, via a vehicle bus 107. Such remote access can be permitted via, for example, any one of a number of different types of wireless networks known in the art.

In the depicted embodiment, the remote access control system 100 includes an insertion device 112, a sensing device 114, and a computer system 116. The insertion device 112 preferably is a dongle or similar device configured to be inserted into the vehicle 102 in an insertion location 117 of the vehicle 102. For example, the insertion location 117 can be in a glove compartment of the vehicle 102, under a steering wheel of the vehicle 102, or in any one of a number of different locations in the vehicle 102.

Also, in one preferred embodiment the insertion location 117 is coupled to or disposed proximate to the vehicle bus 107. In this embodiment, the insertion device 112 may comprise a data link connector (DLC) that is directly connected to the vehicle bus 107, for example at a connection point 119 as shown in FIG. 1. The DLC is a connector in the vehicle 102 that enables a technician to plug in a diagnostic tool, such as the insertion device 112, and troubleshoot the vehicle 102 in one preferred embodiment. In other embodiments, other insertion points may be used, for example a USB port (not depicted) and/or one or more other different types of devices.

Regardless of the location of the insertion location 117, the insertion of the insertion device 112 therein serves as an indication that an authorized individual is, or has recently been, in close physical proximity to the vehicle 102, and that the authorized individual has taken one or more predetermined steps as evidence of this. In certain embodiments, the insertion device 112 may be stored elsewhere in the vehicle 102 and then inserted into the insertion location 117 by an authorized individual (e.g. a technician or vehicle owner) once remote access is needed. In other embodiments, the insertion device 112 may be kept by a vehicle manufacturer, dealer, or service center and then inserted into the insertion location 117 by a technician once remote access is needed, for example when the vehicle 102 requires servicing.

The status of the insertion device 112 (specifically, whether or not the insertion device 112 is inserted into the insertion location 117) can be provided to the computer system 116 via any one of a number of different ways. For example, the insertion device 112 may send a first input 118 to the computer system 116 that indicates the status of the insertion device 112. In another example, the sensing device 114 (described in greater detail below) may determine the status of the insertion device 112, and may then send a second input 120 to the computer system 116 reflecting such status of the insertion device 112.

The sensing device 114 ascertains information regarding the status of one or more switches 121, vehicle components 122, and/or insertion devices 112 representative of whether an authorized individual is, or has recently been, in close proximity to the vehicle 102. The sensing device 114 provides this information to the computer system 116. For example, in the above-described embodiment, the sensing device 114 may include a sensor that is part of, coupled to, and/or disposed in close proximity to the insertion device 112 and/or the insertion location 117, to thereby ascertain the status of the insertion device 112. The sensing device 114 provides information thereof to the computer system 116. In this embodiment, the sensing device 114 may be a separate physical entity and/or may be incorporated as part of the insertion device 112, the insertion location 117, and/or the computer system 116.

In another embodiment, the sensing device 114 may include a sensor that is part of, coupled to, and/or disposed in close proximity to one or more switches 121 and/or vehicle components 122, in order to ascertain the status of such one or more switches 121 and/or vehicle components 122, and/or to determine whether motion has been performed with respect to one or more switches 121 and/or vehicle components 122 in accordance with a predetermined sequence. For example, the sensing device 114 may including a sensor disposed proximate a switch 121 that is activated to a certain predetermined position by an authorized individual near the vehicle 102 when remote access to one or more vehicle modules 106 is requested.

As another example, the sensing device 114 may include a sensor disposed proximate a hood of the vehicle 102, and may ascertain whether or not the hood is in an open position. In another example, the sensing device 114 may include a sensor disposed proximate a glove compartment of the vehicle 102, and may ascertain whether or not the glove compartment is in an open position. In a further example, the sensing device 114 may be configured to sense whether an identification card or other device is swiped or otherwise placed in proximity to the sensing device 114.

In another example, the sensing device 114 may include a sensor disposed proximate a radio of the vehicle 102, and may ascertain whether or not certain buttons of the radio have been pressed in a certain sequence. In yet another example, the sensing device 114 may include one sensor proximate a brake pedal of the vehicle 102 and another sensor proximate a radio of the vehicle 102, and may ascertain whether the brake pedal has been applied a certain number of times and certain buttons of the radio have been pressed, all in a certain, predetermined sequence. The sensing device 114 can be coupled to any number of different types of switches 121 and/or vehicle components 122 to ascertain the status of such switches 121 and/or vehicle components 122, alone or in combination with one another, and to then provide information thereof to the computer system 116. In these embodiments, the sensing device 114 may be a separate physical entity and/or may be incorporated as part of one or more of such switches 121, vehicle components 122, and/or the computer system 116.

In certain embodiments, one or more sensing devices 114 may also be disposed in one or more of the modules 106. For example, in the embodiment depicted in FIG. 1, the BCM 109 includes a sensing device 114, and is connected or otherwise coupled to a switch 121. The switch 121 is configured to provide an indication either as to its own status (e.g. whether the switch 121 is turned on) or some other status of the vehicle 102, such as one or more vehicle components 122. For example, the switch 121 may provide an indication about the above-referenced hood or glove compartment status (or some other status or indication measure, such as those described above) to the BCM 109. The sensing device 114 of the BCM 109 senses the status of the switch 121 and sends information regarding that status on the vehicle bus 107 to the remote access control system 100. This information is received by the computer system 116 of the remote access control system 100. The computer system 116 can similarly receive statuses of any one of a number of different types of switches 121 and/or vehicle components 122 via the vehicle bus 107 from any one of a number of different types of sensing devices 114 that can be part of or coupled to one or more of the modules 106.

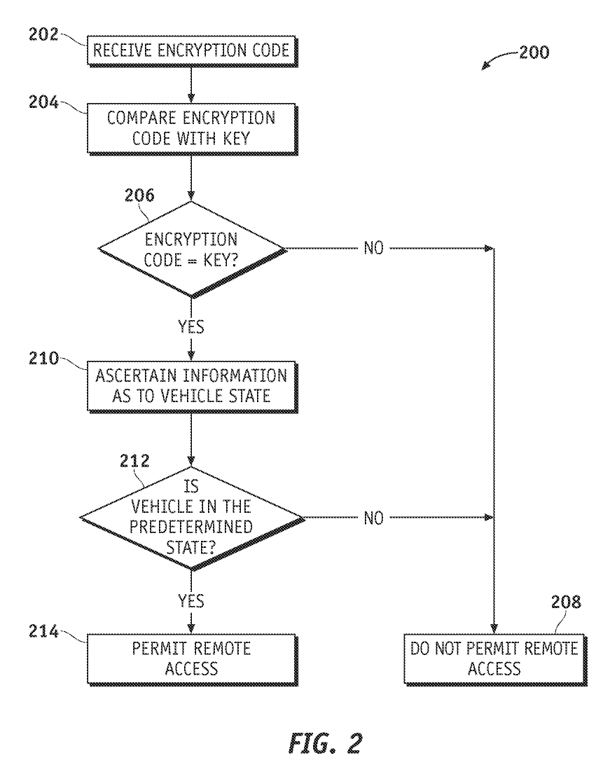

The computer system 116 receives information regarding the status of one or more switches 121, vehicle components 122, and/or the insertion device 112 from the vehicle bus 107, the insertion device 112 and/or the sensing device 114, via the first and/or second inputs 118, 120, respectively. The computer system 116 uses this information to determine whether or not the vehicle 102 is in a predetermined state. Specifically, the vehicle 102 is considered to be in the predetermined state when an authorized individual is, or has recently been, near the vehicle and has engaged one or more switches 121, vehicle components 122, and/or insertion devices 112 in a predetermined manner, as reflected in the status of one or more switches 121, vehicle components 122, and/or the insertion device 112 for example as described above. Based on this determination, the computer system 116 selectively permits access to one or more modules 106 from the authorized user 104 only if the vehicle 102 is in the predetermined state, as will be described in greater detail further below in connection with an exemplary process for controlling remote access depicted in FIG. 2.

In the depicted embodiment, the computer system 116 includes a processor 124, a memory 126, a computer bus 128, an interface 130, and a storage device 132. The processor 124 performs the computation and control functions of the remote access control system 100, and may comprise any type of processor or multiple processors, single integrated circuits such as a microprocessor, or any suitable number of integrated circuit devices and/or circuit boards working in cooperation to accomplish the functions of a processing unit. During operation, the processor 124 executes one or more programs 134 preferably stored within the memory 126 and, as such, controls the general operation of the computer system 116.

The memory 126 stores a program or programs 134 that executes one or more embodiments of a remote access control process of the present invention, discussed in more detail below. The memory 126 can be any type of suitable memory. This would include the various types of dynamic random access memory (DRAM) such as SDRAM, the various types of static RAM (SRAM), and the various types of non-volatile memory (PROM, EPROM, and flash). It should be understood that the memory 126 may be a single type of memory component, or it may be composed of many different types of memory components. In addition, the memory 126 and the processor 124 may be distributed across several different computers that collectively comprise the computer system 116. For example, a portion of the memory 126 may reside on a computer within a particular apparatus or process, and another portion may reside on a remote computer.

The computer bus 128 serves to transmit programs, data, status and other information or signals between the various components of the computer system 116. The computer bus 128 can be any suitable physical or logical means of connecting computer systems and components. This includes, but is not limited to, direct hard-wired connections, fiber optics, and infrared and wireless bus technologies.

The interface 130 allows communication to the computer system 116, for example from a system operator and/or another computer system, and can be implemented using any suitable method and apparatus. It can include one or more network interfaces to communicate to an authorized user 104, other systems or components, one or more terminal interfaces to communicate with technicians, and one or more storage interfaces to connect to storage apparatuses such as the storage device 132.

The storage device 132 can be any suitable type of storage apparatus, including direct access storage devices such as hard disk drives, flash systems, floppy disk drives and optical disk drives. In one exemplary embodiment, the storage device 132 is a program product from which memory 126 can receive a program 134 that executes one or more embodiments of a remote access control process of the present invention. As shown in FIG. 1, the storage device 132 can comprise a disk drive device that uses disks 132 to store data. As one exemplary implementation, the computer system 116 may also utilize an Internet website, for example for permitting or maintaining data or performing operations thereon.

It will be appreciated that while this exemplary embodiment is described in the context of a fully functioning computer system, those skilled in the art will recognize that the mechanisms of the present invention are capable of being distributed as a program product in a variety of forms, and that the present invention applies equally regardless of the particular type of computer-readable signal bearing media used to carry out the distribution. Examples of signal bearing media include: recordable media such as floppy disks, hard drives, memory cards and optical disks (e.g., disk 132), and transmission media such as digital and analog communication links. It will similarly be appreciated that the remote access control system 100 may also otherwise differ from the embodiment depicted in FIG. 1, for example in that the remote access control system 100 may be coupled to or may otherwise utilize one or more remote computer systems and/or other control systems.

FIG. 2 is a flowchart of an exemplary embodiment of a remote access control process 200 for controlling remote access to one or more modules of a vehicle, and that can be implemented in connection with the remote access control system 100 of FIG. 1. As shown in FIG. 2, the remote access control process 200 begins with the step of receiving an encryption code (step 202). In a preferred embodiment, the encryption code is received by the computer system 116 from the authorized user 104 via the wireless network 105 of FIG. 1. The encryption code can be any type of encryption code known in the art, and serves as a first, preliminary check toward ensuring that a source of a request for remote access is in fact an authorized user.

The encryption code is then compared with an encryption code key (step 204), and a determination is made as to whether the encryption code matches the encryption code key (step 206). Preferably, the encryption code is received via the interface 130 of the computer system 116 of FIG. 1. Also, preferably the encryption code key is stored in the memory 126 and/or the program 134 of FIG. 1, and the determination is conducted by the processor 124 using instructions from the program 134.

If it is determined that the encryption code does not match the encryption code key, then remote access to one or more vehicle modules is not permitted (step 208). Alternatively, if it is determined that the encryption code matches the encryption code key, information is obtained as to a state of the vehicle (step 210), and a determination is made therefrom as to whether the vehicle is in a predetermined state (step 212), to ultimately determine whether remote access will be granted. Specifically, the vehicle is considered to be in the predetermined state when an authorized individual is or has recently been in close physical proximity to the vehicle, as evidenced by some predetermined physical measure of the vehicle resulting from one or more steps taken by the authorized individual to engage or otherwise manipulate one or more switches 121, vehicle components 122, and/or insertion devices 112 in a predetermined manner.

In one embodiment, the determination as to whether the vehicle is in the predetermined state is made by the processor 124 of the computer system 116 of FIG. 1, using instructions from the program 134 as well as information provided from the insertion device 112 via the first input 118 and/or the vehicle bus 107. For example, the vehicle 102 may be considered to be in the predetermined state if the insertion device 112 is inserted into the insertion location 117 of the vehicle 102. As discussed above, the insertion location 117 can be in a glove compartment of the vehicle 102, under a steering wheel of the vehicle 102, or in one of a number of different locations in the vehicle 102.

In another embodiment, the determination as to whether the vehicle is in the predetermined state is determined by the processor 124 of the computer system 116 of FIG. 1, using instructions from the program 134 as well as information provided from one or more sensing device 114 via the second input 120 and/or the vehicle bus 107. For example, as mentioned above, information as to whether the insertion device 112 is inserted into the insertion location 117 of the vehicle 102 (which would indicate that the vehicle 102 is in the predetermined state) can be provided to the computer system 116 by one or more sensing devices 114 via the second input 120 and/or the vehicle bus 107. As another example, the vehicle 102 may be considered to be in the predetermined state if motion has been performed with respect to one or more switches 121 and/or vehicle components 122 and/or if one or more switches 121 and/or vehicle components 122 have a status resulting from one or more predetermined actions of an authorized user, such as the activation of a switch to a predetermined position, the opening of a hood of the vehicle 102 or a glove compartment of the vehicle 102, the pressing of certain buttons of a radio of the vehicle 102 in a certain sequence, application of a brake pedal of the vehicle 102 a certain number of times, other manipulations by a user, and/or combinations thereof, for example in a predetermined sequence. In yet another example, the vehicle 102 may be considered to be in the predetermined state if an identification card or other device is swiped or otherwise placed in proximity to the sensing device 114. Such information can similarly be provided to the computer system 116 by one or more sensing device 114 via the second input 120 and/or the vehicle bus 107.

It will be appreciated that any number of predetermined conditions, representing the status of any number of different types of switches 121, vehicle components 122, and/or insertion devices 112, and/or motion performed with respect thereto, can be used to determine whether or not the vehicle 102 is in the predetermined state. Preferably, such predetermined conditions and states are selected such that the switches 121, vehicle components 122 and/or insertion devices 112 would not normally be in such states, and therefore the predetermined conditions would not normally be met, unless an authorized individual is or has recently been in close proximity to the vehicle 102 and has taken specified predetermined steps as evidence of this. In addition, one or more time limits may be introduced with respect to the predetermined conditions, so that the vehicle will only be considered to be in the predetermined state if an authorized individual has been in close physical proximity to the vehicle within a relatively short, predetermined amount of time.

If it is determined in step 212 that the vehicle is not in the predetermined state, then remote access to one or more vehicle modules is not permitted (step 208). Alternatively, if it is determined in step 212 that the vehicle is in the predetermined state, then remote access to one or more vehicle modules is permitted (step 214). In a preferred embodiment, such remote access is permitted between the authorized user 104 and one or more modules 106 of FIG. 1 via a wireless network, such as the wireless network 105 depicted in FIG. 1.

Thus, in the depicted embodiment, remote access is permitted only upon the satisfaction of two conditions, namely that (i) the correct encryption code is provided (as determined in step 206), and (ii) the vehicle is in the predetermined state (as determined in step 212). In other embodiments, remote access may be permitted based solely upon satisfaction of the second condition, namely that the vehicle is in the predetermined state (as determined in step 212). This second condition is intended to be a more secure condition that can only be satisfied if an authorized individual is, or has recently been, in close proximity to the vehicle. The second condition thereby provides potentially greater protection than the use of an encryption code.

Also, it will be appreciated that certain steps or groups of steps of the remote access control process 200 may occur simultaneously and/or in a different order than that depicted in FIG. 2. For example, the steps pertaining to the encryption code (steps 202-206) may occur simultaneously or in either order as the steps pertaining to the state of the vehicle (steps 210-212). In addition, as noted above, in certain embodiments steps 202-206 may not be necessary.

Accordingly, a system and method for controlling remote access to a vehicle is provided. The system and method permit remote access to one or more modules of a vehicle by an authorized user. The system and method also permit such access only if the vehicle is in a predetermined state, indicating that an authorized individual is, or has recently been, in close physical proximity to the vehicle.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for controlling remote access to a module of a vehicle, the method comprising the steps of:
determining whether the vehicle is in a predetermined state; and
permitting remote access to the module only on the condition that the vehicle is in the predetermined state.

2. The method of claim 1, wherein the step of determining whether the vehicle is in the predetermined state comprises the step of:
determining whether an authorized person is, or has recently been, in close proximity to the vehicle.

3. The method of claim 1, wherein the vehicle includes a hood, and the step of determining whether the vehicle is in the predetermined state comprises the step of:
determining whether the hood is in an open position.

4. The method of claim 1, wherein the vehicle includes a designated switch, and the step of determining whether the vehicle is in the predetermined state comprises the step of:
determining whether the designated switch is in a predetermined position.

5. The method of claim 1, wherein the vehicle includes one or more designated components, and the step of determining whether the vehicle is in the predetermined state comprises the step of:
determining whether motion has been performed with respect to the one or more designated components in accordance with a predetermined sequence.

6. The method of claim 1, wherein the step of determining whether the vehicle is in the predetermined state comprises the step of:
determining whether a designated device has been inserted into the vehicle.

7. The method of claim 1, further comprising the steps of:
requiring an encryption code for permitting remote access to the module; and
permitting remote access to the module only on the further condition that the encryption code has been provided.

8. The method of claim 1, wherein the step of permitting remote access to the module comprises permitting remote access over a wireless network.

9. A program product for controlling remote access to a module of a vehicle, the program product comprising:
a program configured to at least facilitate:
determining whether the vehicle is in a predetermined state; and
permitting remote access to the module only on the condition that the vehicle is in the predetermined state; and
a computer-readable signal-bearing media bearing the program.

10. The program product of claim 9, wherein the program is configured to at least facilitate determining whether an authorized person is, or has recently been, in close proximity to the vehicle.

11. The program product of claim 9, wherein the vehicle includes a hood, and the program is configured to at least facilitate determining whether the vehicle is in the predetermined state by at least facilitating a determination as to whether the hood is in an open position.

12. The program product of claim 9, wherein the vehicle includes a designated switch, and the program is configured to at least facilitate determining whether the vehicle is in the predetermined state by at least facilitating a determination as to whether the designated switch is in a predetermined position.

13. The program product of claim 9, wherein the vehicle includes one or more designated components, and the program is configured to at least facilitate determining whether the vehicle is in the predetermined state by at least facilitating a determination as to whether motion has been performed with respect to the one or more designated components in accordance with a predetermined sequence.

14. The program product of claim 9, wherein the program is configured to at least facilitate determining whether the vehicle is in the predetermined state by at least facilitating a determination as to whether a designated device has been inserted into the vehicle.

15. The program product of claim 9, wherein the program is further configured to at least facilitate:
requiring an encryption code for permitting remote access to the module; and
permitting remote access to the module only on the further condition that the encryption code has been provided.

16. A system for controlling remote access to a module of a vehicle, the system comprising:
a sensing device configured to sense a physical vehicle measure; and
a processor coupled to the sensing device and configured to at least facilitate:
determining whether the vehicle is in a predetermined state, based on the physical vehicle measure; and
permitting remote access to the module only on the condition that the vehicle is in the predetermined state.

17. The system of claim 16, wherein the physical vehicle measure indicates whether an authorized person is, or has recently been, in close proximity to the vehicle.

18. The system of claim 16, wherein the vehicle includes a hood, and the physical vehicle measure comprises an open position of the hood.

19. The system of claim 16, further comprising:
a device configured to be inserted into the vehicle;
wherein the processor is configured to at least facilitate determining whether the vehicle is in the predetermined state by at least facilitating a determination as to whether the device has been inserted into the vehicle.

20. The system of claim 16, wherein the physical vehicle measure comprises whether a designated device has been moved in close proximity to the sensing device.
